(19) United States
(12) Patent Application Publication
(10) Pub. No.: US 2026/0080786 A1
(43) Pub. Date: Mar. 19, 2026

(54) Radar-Based Localization for Aircraft

(71) Applicant: Joby Aero, Inc., Santa Cruz, CA (US)

(72) Inventors: Michael BURGHARDT, Santa Cruz, CA (US); Andreas HADERER, Perg (AT); Karsten Andreas MUELLER, Karlsruhe (DE); Martin SCHERHÄEUFL, Eidenberg, Upper Austria (AT)

(21) Appl. No.: 18/790,949

(22) Filed: Jul. 31, 2024

Related U.S. Application Data
(60) Provisional application No. 63/516,696, filed on Jul. 31, 2023.
(60) Provisional application No. 63/516,712, filed on Jul. 31, 2023.

(51) Int. Cl. G08G 5/72; G01S 13/88; G01S 13/92

(52) U.S. Cl. CPC G08G 5/723; G01S 13/882; G01S 13/92

(57) ABSTRACT

A method for radar-based localization includes accessing data from one or more radar systems on the aircraft, computing a velocity estimate of the aircraft based at least in part on the data from the one or more radar systems on the aircraft, computing a radar image of a landscape below the aircraft based at least in part on the velocity estimate of the aircraft, and computing a position estimate of the aircraft based at least in part on a localization of the computed radar image on a map of the landscape.

### CROSS-REFERENCE TO RELATED APPLICATIONS

The present application is related and has right of priority to U.S. Provisional Patent Application No. 63/516,696, which was filed in the USPTO on Jul. 31, 2023, and to U.S. Provisional Patent Application No. 63/516,712, which was filed in the USPTO on Jul. 31, 2023, both of which are incorporated by reference in their entireties.

### FIELD

The present disclosure relates generally to radar-based aircraft localization.

### BACKGROUND

During navigation, aircraft can utilize data from a global navigation satellite system (GNSS) for measuring a location of the aircraft. The accuracy of GNSS systems varies by environment and can be unavailable in certain instances. Moreover, GNSS-based positioning estimates can be coarse and not provide a required integrity for autonomous flight. In general, conventional GNSS systems can lack the availability, continuity, and integrity needed for aircraft navigation during autonomous flight and other operating conditions.

Systems and methods for high-integrity location estimates for aircraft and that are not reliant upon GNSS data would be useful.

### SUMMARY

Aspects and advantages of embodiments of the present disclosure will be set forth in part in the following description, or may be learned from the description, or may be learned through practice of the embodiments.

In example embodiments, a method for radar-based localization includes: accessing, with a computing device on an aircraft, data from one or more radar systems on the aircraft; computing, with the computing device, a velocity estimate of the aircraft based at least in part on the data from the one or more radar systems on the aircraft; computing, with the computing device, a radar image of a landscape below the aircraft based at least in part on the velocity estimate of the aircraft; and computing, with the computing device, a position estimate of the aircraft based at least in part on a localization of the computed radar image on a map of the landscape.

In example embodiments, a system for radar-based localization includes one or more processors and one or more non-transitory computer-readable media that store instructions that are executable by the one or more processors to perform operations. The operations include accessing data from one or more radar systems on the aircraft, computing a velocity estimate of the aircraft based at least in part on the data from the one or more radar systems on the aircraft, computing a radar image of a landscape below the aircraft based at least in part on the velocity estimate of the aircraft, and computing a position estimate of the aircraft based at least in part on a localization of the computed radar image on a map of the landscape.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 is a perspective view of an aircraft according to an example embodiment of the present disclosure in a thrust-borne flight regime.

FIG. 2 is a perspective view of the example aircraft of FIG. 1 in a horizontal flight configuration.

FIG. 3 is a schematic view of an electrical system according to an example embodiment of the present disclosure.

FIG. 4 is a schematic view of radar systems of an aircraft according to an example embodiment of the present disclosure.

FIG. 5 is a schematic view of an avionics system according to an example embodiment of the present disclosure.

FIG. 6 is a schematic view of a positioning system according to an example embodiment of the present disclosure.

FIG. 7 is a schematic view of a radar-based altimeter for an aircraft according to an example embodiment of the present disclosure.

FIG. 8 is another schematic view of the example radar-based altimeter of FIG. 7.

FIG. 9 is a schematic view of a radar-based velocity estimator for an aircraft according to an example embodiment of the present disclosure.

FIG. 10 is a radar map according to an example embodiment of the present disclosure.

FIG. 11 is a flowchart of a radar-based localization method for an aircraft according to an example embodiment of the present disclosure.

FIG. 12 is a diagram of example computing components according to an example embodiment of the present disclosure.

Repeat use of reference characters in the present specification and drawings is intended to represent the same or analogous features or elements of the present invention.

### DETAILED DESCRIPTION

The present subject matter may advantageously provide a positioning system, which can utilize radar measurements to provide estimates of various operational parameters of the aircraft, such as a three-dimensional position estimate, a three-dimensional velocity estimate, and/or a three-dimensional attitude estimate for the aircraft. Moreover, the positioning system may provide such estimates during all phases of flight, e.g., without reference to a global navigation satellite system (GNSS). The position estimates may be used to assist with fully autonomous flight of an aircraft. The radar-based localization components of the positioning system may advantageously increase integrity of the positioning system and/or allow for navigation of the aircraft when GNSS navigation inputs are unavailable. The positioning system may thus provide accurate position and velocity estimates for the aircraft, e.g., even without GNSS measurements.

In example embodiments, the positioning system may be a multi-sensor navigation system that combines data from various inputs, such as a GNSS system, an inertial measurement unit (IMU), a pressure sensor, and a plurality of radar systems. The radar measurements can advantageously stabilize the estimates of the multi-sensor navigation system to avoid long-term position drifts. During standard operation, the positioning system can use all available inputs, such as the GNSS system, the IMU, the pressure sensor, and/or the radar-based velocity estimates to provide position estimates with suitable integrity. Thus, e.g., when the GNSS system is available, the position estimate from the radar-based localization may be used to verify the integrity of the GNSS position data. Conversely, when the GNSS system is unavailable, the position of the aircraft may be estimated via radar-based localization using map localization, e.g., along with data from the IMU and/or pressure sensor.

The positioning system can utilize a variety of radar systems to provide position estimates. For example, the aircraft may include forward-looking detect-and-avoid (DAA) radar systems, which can detect cooperative and non-cooperative objects in a direction of movement, and may also include side-looking radar systems, which may be used for radar-based localization during flight. Other radar systems may also be used. The radar-based localization components may utilize the side-looking radar antennas to implement displaced antenna and synthetic aperture radar (SAR) processing in order to compute velocity estimates over the ground and absolute position estimates by localizing on a radar map, such as a radar reflectivity map. Additionally or alternatively, it will be understood that direct velocity estimates via Doppler may be used in the present disclosure, e.g., to assist with the absolute position estimates. In example embodiments, the forward-looking DAA radar antennas may also be used to implement the radar-based localization. For instance, the forward-looking DAA radar antennas may have a field of view of about plus or minus one hundred and ten degrees (±110°) to assist with forming a radar image, such as an SAR image.

As noted above, the radar-based localization may support the positioning system to provide position estimates with desired integrity when GNSS is unavailable. The radar-based localization may include four estimators: (1) a radar altimeter configured to estimate a height of the aircraft over ground; (2) a radar velocity estimator configured to estimate of a velocity of the aircraft over the ground; (3) a radar image generator configured to generate a radar image, such as an SAR image, of the ground below the aircraft; and (4) a position estimator that is configured to estimate a position of the aircraft by localizing the radar image on a map, such as a radar reflectivity map. The estimated position of the aircraft may advantageously not suffer from drift. Each of the four estimators may not require additional data inputs from the positioning system, such as GNSS data.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are described below in the context of an example aircraft 100 configured for vertical take-off and landing as well as horizontal flight. It will be understood that aircraft is provided by way of example only and that the present subject matter is not limited to aircraft 100 or vertical take-off and landing aircraft more generally. The present subject matter including may be utilized in other aircraft in other example embodiments. For example, the present subject matter may be used in or with conventional take-off and landing aircraft, VTOL aircraft, multi-modal aircraft, tilt propeller aircraft, helicopters, etc.

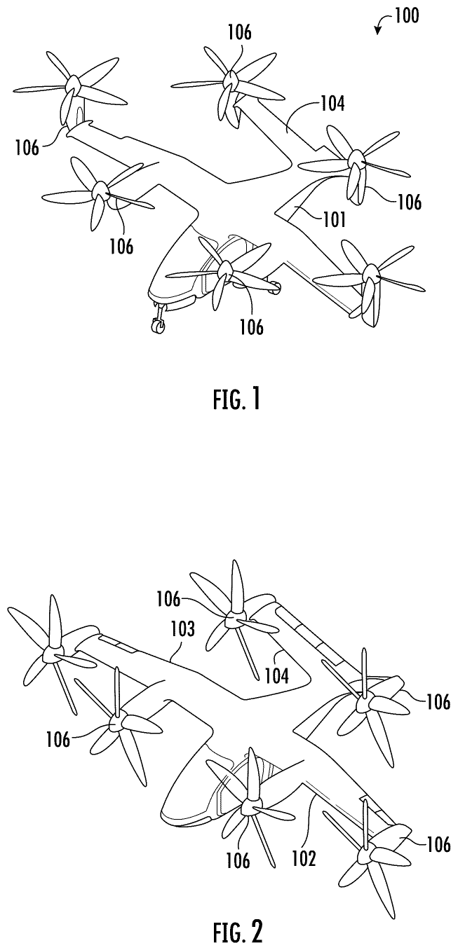

FIGS. 1 and 2 are perspective views of an aircraft 100 configured for vertical take-off and landing as well as horizontal flight according to an example embodiment of the present disclosure. In FIG. 1, aircraft 100 is in a thrust-borne flight regime or hover configuration. In FIG. 2, the aircraft 100 is in a wing-borne flight regime or high-speed configuration. As shown in FIGS. 1 and 2, the aircraft 100 may include tilt propulsion units 106 with bladed propellers powered by electric motors. The tilt propulsion units 106 may provide thrust during take-off and forward flight of the aircraft 100. Moreover, the tilt propulsion units 106 may be rotated relative to fixed wings of the aircraft 100 between the thrust-borne flight regime shown in FIG. 1 and the wing-borne flight regime shown in FIG. 2.

In the thrust-borne flight regime, the propellers of the tilt propulsion units 106 may be oriented to primarily or predominately provide vertical thrust for take-off and landing. In the wing-borne flight regime, the propellers of the tilt propulsion units 106 may be oriented to primarily or predominately provide forward thrust for high-speed flight. In example embodiments, both the electric motor and the propellers of the tilt propulsion units 106 may be together rotated when the aircraft 100 adjusts between the thrust-borne flight regime of FIG. 1 and the wing-borne flight regime of FIG. 2. Thus, the tilt propulsion units 106 may allow for directional change of thrust without requiring any gimbaling, or other method, of torque drive around or through a rotating joint.

In some example aspects, the aircraft 100 take offs from the ground with vertical thrust from the tilt propulsion units 106 in the thrust-borne flight regime. As the aircraft 100 gains altitude, the tilt propulsion units 106 may begin to tilt forward in order to begin forward acceleration. As the aircraft 100 gains forward speed, airflow over the wings results in lift, such that the tilt propulsion units 106 become less important and then unnecessary for maintaining altitude using vertical thrust. Once the aircraft 100 reaches sufficient forward speed, the tilt propulsion units 106 may be oriented to provide forward thrust in the wing-borne flight regime, and the aircraft 100 may continue to gain speed.

As shown in FIGS. 1 and 2, the aircraft 100 may include an aircraft body 101 and fixed wings 102, 103, which may be forward swept wings, including a left wing 102 and a right wing 103. At least some of tilt propulsion units 106 may be mounted on the wings 102, 103. As noted above, the tilt propulsion units 106 may include electric motors and propellers, which are configured to articulate between the thrust-borne flight regime shown in FIG. 1 and the wing-borne flight regime shown in FIG. 2.

The aircraft body 101 may extend rearward and be attached to raised rear stabilizers 104. At least some of tilt propulsion units 106 may also be attached to the rear stabilizers 104. The tilt propulsion units 106 on the rear stabilizers 104 may be articulated between the thrust-borne flight regime shown in FIG. 1 and the wing-borne flight regime shown in FIG. 2 by rotating along a pivot axis such that the nacelle, the electric motor, and the propeller deploy in unison.

The aircraft 100 may also include any suitable set of flight actuators, which functions to transform aerodynamic forces/moments of the aircraft to affect aircraft control. Flight actuators may include control surface actuators (e.g., configured to drive control surfaces), tilt linkages (e.g., which actuate the tilt propulsion units 106 between the forward flight and hover configurations), variable blade pitch actuators (e.g., for variable blade pitch for the propellers of the tilt propulsion units 106), and/or any other suitable actuators. Control surfaces may include flaps, elevators, ailerons, rudders, ruddervators, spoilers, slats, air brakes, and/or any other suitable control surfaces.

In the example shown in FIGS. 1 and 2, the aircraft 100 may include two passenger seats side by side, as well as landing gear under the aircraft body 101. Although aircraft 100 is shown as a two-passenger aircraft, other numbers of passengers may be accommodated in other example embodiments of the present disclosure. The landing gear (e.g., retractable landing gear, fixed landing gear) may be configured to structurally support the aircraft 100 when the aircraft 100 is in contact with the ground and/or maneuver the aircraft 100 during taxi.

Again, it will be understood that the aircraft 100 is provided by way of example. The present subject matter may also be used in or with other aircraft in alternative example embodiments. For example, the present subject matter may be used in or with fixed-wing aircraft, VTOL aircraft, multi-modal aircraft, tilt propeller aircraft, helicopters, etc. The propulsion units may have a fixed or variable pitch. The aircraft may include an all-electric powertrain, e.g., with battery powered electric motors, for the propulsion units. In alternative example embodiments, may include a hybrid powertrain, such as a gas-electric hybrid with an internal-combustion generator, or an internal-combustion powertrain, such as a gas-turbine engine, a turboprop engine, etc. The present subject matter may be used in or with conventional take-off and landing aircraft.

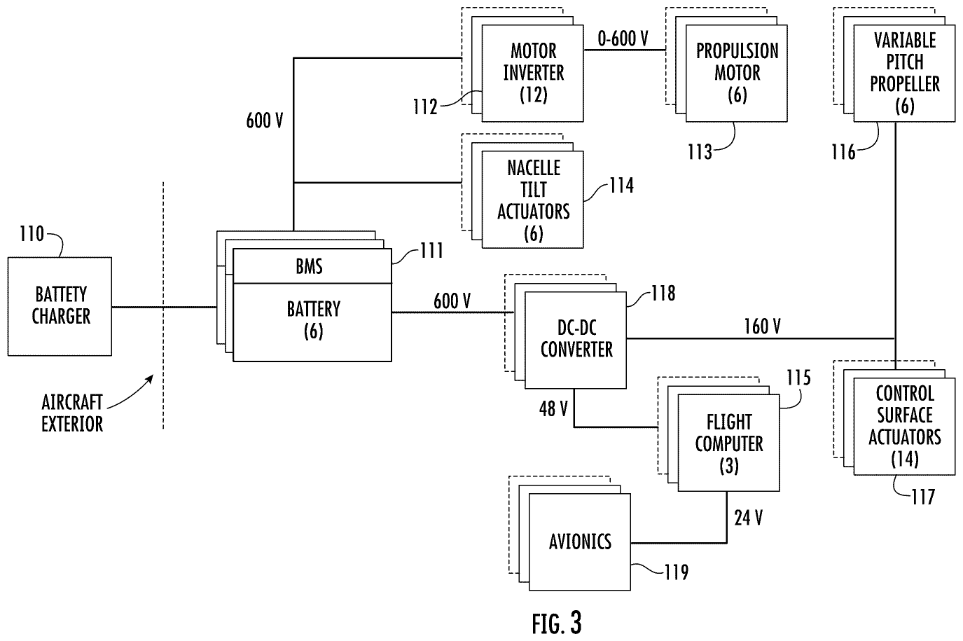

FIG. 3 is schematic view of an electrical system for the aircraft 100. As shown, the electrical system may include batteries 111, e.g., six (6) batteries 111. In an example, each of the batteries 111 may supply two power inverters 112. Thus, an example implementation of the electrical system may include twelve (12) power inverters 112. The nominal voltage of the batteries may be six hundred volts (600V) in example embodiments. Each of the propulsion motors 113 may include two sets of windings, with each motor 113 powered by two inverters 112, one for each set of windings. The two inverters 112 powering a single motor 113 each may be supplied power by different batteries 111. In addition to supplying power to the motor inverters 112, the battery 111 may also supply power to tilt actuators 114, such as tilt actuators, which are used to deploy and stow the tilt propulsion units 106 during various flight modes, such as the thrust-borne flight regime and the wing-borne flight regime.

A flight computer 115 may monitor the current from each of the motor inverters 112, which are supplying power to the winding sets in the motors 113. The flight computer 115 may also control the motor current supplied to each of the windings of the motors 113. In example embodiments, the batteries 111 may also supply power to blade pitch motors 116 and position encoders of the tilt propulsion units 106. The batteries 111 may also supply power to one or more actuators 117, such as control surface actuators configured to adjust the position of various control surfaces on the aircraft 100.

The blade pitch motors 116 and the actuators 117 may receive power through a DC-DC converter 118, which may step the voltage from six hundred volts (600V) to one hundred and sixty volts (160V), for example. A suite of avionics 119 may also be coupled to the flight computer 115. A battery charger 110 may be used to recharge the batteries 111, and the battery charger 110 may be located external to the aircraft 100 and ground based.

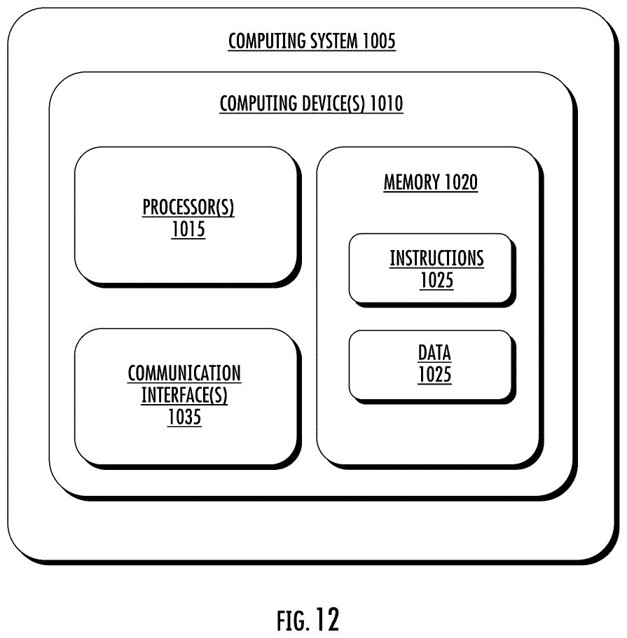

The flight computer 115 may be configured to generate commands that may be transmitted to and interpreted by the inverters 112 and/or actuators 117 to control aircraft flight. In example embodiments with a plurality of flight computers 115, each of the flight computers 115 may be a substantially identical instance of the same computer architecture and components, but can additionally or alternatively be instances of distinct computer architectures and components (e.g., generalized processors manufactured by different manufacturers). The flight computers 115 may include CPUs, GPUs, TPUs, ASICs, microprocessors, and/or any other suitable set of processing systems. In example embodiments, each of the flight computers 115 performs substantially identical operations (e.g., processing of data, issuing of commands, etc.) in parallel, and are connected (e.g., via the distribution network) to the same set of flight components. FIG. 12 provides additional detail regarding example components of a computing system, such as a flight computer 115.

The flight computer 115 may be programmed to assist control operation of the aircraft 100. For example, flight computer 115 may receive positioning data and/or navigation data from avionics 119, and flight computer 115 may generate commands that may be transmitted to and interpreted by the inverters 112 and/or actuators 117 to control aircraft flight in order navigate the aircraft 100 to a destination.

As described in greater detail below, the avionics 119 may be programmed or configured to provide a positioning system 200 (FIG. 5) that computes a position estimate, a velocity estimate, and/or an attitude estimate for the aircraft 100 based at least in part on radar localization. The positioning system 200 may provide the position estimate for the aircraft 100 during all phases of flight, e.g., without reference to a global navigation satellite system (GNSS).

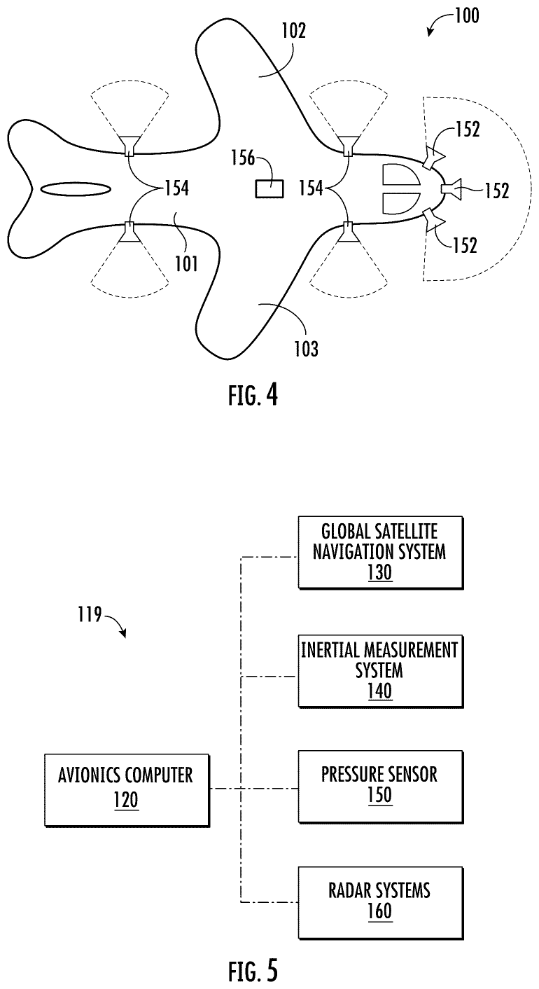

FIGS. 4 and 5 are schematic views of aircraft 100 and certain portions of the avionics 119 of aircraft 100. As shown in FIG. 5, avionics 119 may include an avionics computer 120. The avionics computer 120 may be configured to access data from various components of the avionics 119. For instance, avionics computer 120 may be in signal communication with systems of avionics 119, such as a global satellite navigation system 130, an inertial measurement system 140, a pressure sensor 150, and radar systems 160, e.g., via a communication bus or other suitable wired or wireless communication mechanism. Avionics computer 120 may thus receive data from and/or transmit data to the global satellite navigation system 130, the inertial measurement system 140, the pressure sensor 150, and the radar systems 160. The avionics computer 120 may also be configured to process data in order to, e.g., estimate a position, velocity, and/or attitude of aircraft 100 during flight. As another example, avionics computer 120 may be configured to generate data corresponding to navigation instructions for aircraft 100 during autonomous flight, e.g., based at least in part on the estimates of the position, velocity, and/or attitude of aircraft 100.

The global satellite navigation system 130 may be configured for receiving signals from satellites and calculating a position of the aircraft 100 based on the signals from the satellites. In example embodiments, the global satellite navigation system 130 may be a global positioning system (GPS), a global navigation satellite system (GLONASS), a BeiDou navigation satellite system, and/or a Galileo system. The avionics computer 120 may receive data from the global satellite navigation system 130 corresponding to estimates of position of the aircraft 100 based on signals from the satellites. As another example, the avionics computer 120 may receive data from the global satellite navigation system 130 and compute estimates of the position of the aircraft 100 based on the data.

The inertial measurement system 140 may be configured for measuring and reporting various operating parameters of the aircraft 100, such as a specific force, an angular rate, an orientation, etc., of aircraft 100 during flight. The inertial measurement system 140 may include various sensors, including one or more of an accelerometer, a gyroscope, and a magnetometer. Moreover, in certain example embodiments, the inertial measurement system 140 may include one accelerometer, one gyroscope, and one magnetometer per each principal axis of the aircraft, namely pitch, roll and yaw. The data from the inertial measurement system 140 may be used to calculate attitude, velocity, and position of the aircraft 100 for the three principal axes of the aircraft. It will be understood that the arrangement of the inertial measurement system 140 described above is provided by way of example and that the inertial measurement system 140 may be any suitable conventional inertial measurement system, which are well understood by those of skill in the art. As noted above, the inertial measurement system 140 may be in signal communication with the avionics computer 120. Thus, the avionics computer 120 may receive data from the inertial measurement system 140 corresponding to estimates of the attitude, velocity, and position of the aircraft 100 based on inertial measurements by the inertial measurement system 140. As another example, the avionics computer 120 may receive data from the inertial measurement system 140 and compute estimates of attitude, velocity, and position of the aircraft 100 based on the inertial measurements by the inertial measurement system 140.

The pressure sensor 150 may be configured for measuring an air pressure about the aircraft 100 and reporting an altitude of the aircraft 100 based on the measured air pressure. Thus, the pressure sensor 150 may include a barometer that senses ambient, static air pressure, e.g., via a static port on the aircraft body 101. It will be understood that the arrangement of the pressure sensor 150 described above is provided by way of example and that the pressure sensor 150 may be any suitable conventional pressure altimeter, which are well understood by those of skill in the art. As noted above, the pressure sensor 150 may be in signal communication with the avionics computer 120. Thus, the avionics computer 120 may receive data from the pressure sensor 150 corresponding to estimates of altitude of the aircraft 100 based on pressure measurements by the pressure sensor 150. As another example, the avionics computer 120 may receive data from the pressure sensor 150 and compute estimates of altitude based on the pressure measurements by the pressure sensor 150.

Radar systems 160 may be configured to detect objects via reflected electromagnetic energy. The aircraft 100 may include various radar systems 160. For example, with reference to FIG. 4, radar systems 160 may include a forward-looking detect-and-avoid (DAA) radar system 162 with antennas oriented towards a forward direction of flight for the aircraft 100 and that are configured for transmitting and receiving radar signals in order to detect cooperative and non-cooperative objects in a direction of movement of the aircraft 100. As another example, radar systems 160 may include side-looking radar systems 164 with side-looking antennas that are configured for transmitting and receiving radar signals in order to create two-dimensional radar images or three-dimensional reconstructions of a landscape below the aircraft 100 during flight, e.g., via displaced antenna and synthetic aperture radar (SAR) processing. As another example, with reference to FIG. 4, radar systems 160 may include a downwardly-facing radar system 166 with antennas oriented downwardly towards the ground below the aircraft 100 and that are configured for transmitting and receiving radar signals in order to estimate the altitude of the aircraft 100 over the ground and/or for three-dimensional (3D) velocity estimation. It will be understood that the arrangement of the radar systems 160 described above and shown in FIG. 4 is provided by way of example and that the radar systems 160 may include other arrangements and/or types of radar systems in addition to or as an alternative to those described above. The radar systems 160 may be in signal communication with the avionics computer 120. Thus, the avionics computer 120 may receive data from the radar systems 160 corresponding to estimates of altitude, velocity, and/or position of the aircraft 100 based on radar measurements by the radar systems 160. As another example, the avionics computer 120 may receive data from the radar systems 160 and compute estimates of altitude, velocity, and/or position of the aircraft 100 based on the radar measurements by the radar systems 160.

In example embodiments with a plurality of avionics computer 120, each of the avionics computer 120 may be a substantially identical instance of the same computer architecture and components, but can additionally or alternatively be instances of distinct computer architectures and components (e.g., generalized processors manufactured by different manufacturers). The avionics computer 120 may include CPUs, GPUs, TPUs, ASICs, microprocessors, and/or any other suitable set of processing systems. In example embodiments, each of the avionics computer 120 performs distinct operations (e.g., processing of data, estimating of flight parameters, etc.) in parallel, and are connected (e.g., via the distribution network) to the avionics computers 120. FIG. 12 provides additional detail regarding example components of a computing system, such as an avionics computer 120.

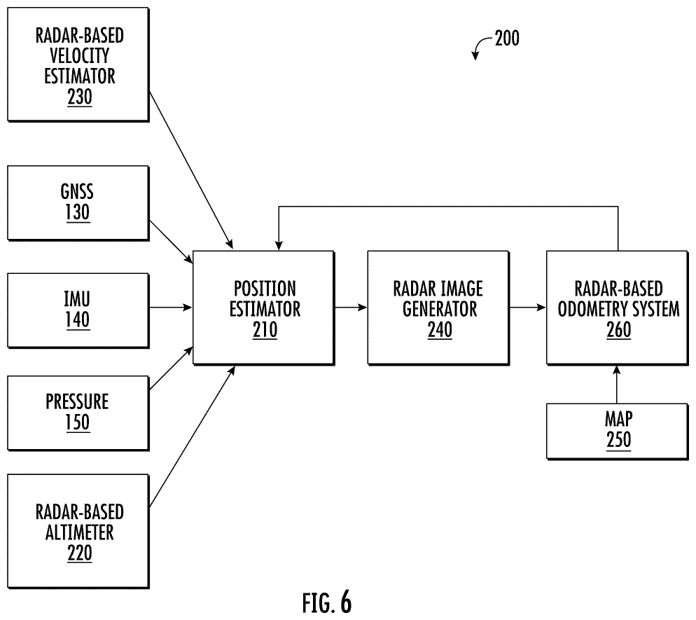

FIG. 6 is a schematic view of a positioning system 200 for an aircraft according to an example embodiment of the present disclosure. It will be understood that only relevant portions of the complete positioning system for an aircraft are shown in FIG. 6. Other components are omitted for the sake of brevity. Thus, the positioning system 200 may include additional positioning components in other example embodiments. The positioning system 200 in FIG. 6 may be implemented as at least a portion of, or otherwise be in communication with, the avionics computer 120 and/or the flight computer 115. Positioning system 200 is described in greater detail below in the context of the aircraft 100, which was described with reference to FIGS. 1 through 5. In this regard, estimates of the altitude, velocity, and/or position of the aircraft 100 may be computed by the positioning system 200 to assist with operating or navigating the aircraft 100. However, it will be understood that the positioning system 200 may be used in or with other aircraft in alternative example embodiments. As noted above, aircraft 100 may operate without access to GNSS positioning data. The positioning system 200 may provide radar-based position estimates for the aircraft 100 during all phases of flight, e.g., without reference to GNSS positioning data. In addition, even with access to GNSS positioning data, the positioning system 200 may provide high integrity position estimates by also utilizing radar-based position estimates in combination with the GNSS positioning data.

In example embodiments, the positioning system 200 may be programmed or configured with one or more subsystems. Each subsystem of the positioning system 200 may be configured as a packaged functional hardware unit or a software program that performs a particular function or series of related functions. For instance, the subsystems may be self-contained hardware or software components for the performing the operations, and implementing the components, shown in FIG. 6.

As shown in FIG. 6, the positioning system 200 may include a plurality of inputs for a position estimator 210. Moreover, the positioning system 200 may include one or more of a radar-based altimeter 220, a radar-based velocity estimator 230, GNSS system 130, IMU system 140, and the pressure altimeter 150, each of which may provide data to the position estimator 210 to assist with calculation of a position estimate for the aircraft 100.

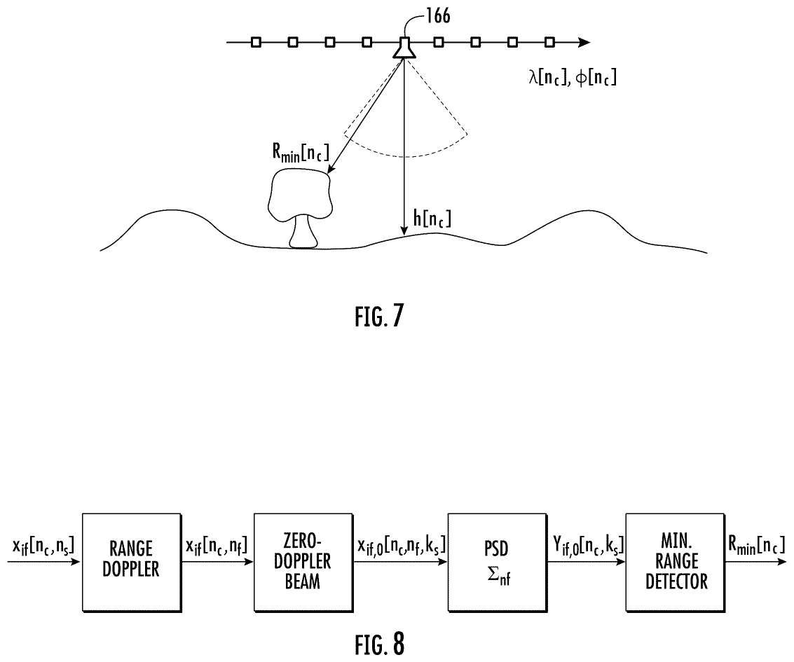

The radar-based altimeter 220 may be configured to measure the height of the aircraft 100 over the ground. As shown in FIG. 7, the radar system 160 may be configured to illuminate an extended area on the ground depending on the beamwidth of the radar system 160. Thus, the radar-based altimeter 220 may be configured to detect a dominant reflection(s) such that the radar-based altimeter 220 is configured to estimate the distance to the reflection from a treetop (or other object above the ground) rather than the desired height of the aircraft 100 over the ground. The radar-based altimeter 220 may utilize one or more of the radar systems 160 to transmit radar signals and estimate the height of the aircraft 100 over the ground (or the distance to objects on the ground) via the reflected radar signals. In example embodiments, the radar-based altimeter 220 may utilize the antennas of the downwardly-facing radar system 166 to transmit radar signals and estimate the height of the aircraft 100 over the ground via the reflected radar signals.

The radar-based altimeter 220 may be configured to measure the height of the aircraft 100 over the ground via suitable algorithms or methods. In example embodiments, with reference to FIG. 8, the radar-based altimeter 220 may be configured to estimate the height, h[n_{c}], where n_{c} corresponds to a number of transmitted chirps, of the aircraft 100 over the ground via the following, which is provided by way of example. The radar-based altimeter 220 may be configured to detect a first dominant reflection, e.g., such that the radar-based altimeter 220 is configured to estimate the distance to the reflection from the ground, a treetop (or other object) on the ground, etc. As the aircraft 100 moves, zero-Doppler beam processing sharpens the radar signal from the radar system 160 in the direction of movement. In addition, the zero-Doppler beam processing provides higher signal-to-noise ratio (SNR), which simplifies detection of the first dominant reflection.

The two-dimensional input data for the radar-based altimeter 220 may be given as a function of a chirp index n_{c} and a fast time index ns as follows.

$${x}_{if} [ {n}_{c} , {n}_{s} ] for : {n}_{c} = - \frac{{n}_{c}}{2} , - \frac{{n}_{c}}{2} + 1 , … , \frac{{n}_{c}}{2} and$$

$${n}_{s} = - \frac{{n}_{s}}{2} , - \frac{{n}_{s}}{2} + 1 , … , \frac{{n}_{s}}{2}$$

The input data may be split in N_{f} equally sized frames, with each frame containing N_{c}/N_{f} chirps. For each frame, the zero-Doppler beam X_{if,0} may be calculated and the power spectral density may then be evaluated by summing the squared zero-Doppler signals, where kₛ refers to the spectral index of the fast time samples, as follows.

$${Y}_{if , 0} [ {n}_{c} , {k}_{s} ] = \sqrt{\frac{1}{{N}_{f}} {\sum }_{{n}_{f}} {\vert {X}_{if , 0} [ {n}_{c} , {k}_{s} ] \vert}^{2}}$$

The spectral density may be more robust when the radar signals from the radar system 160 are corrupted by interference. A cell averaging algorithm may calculate a threshold,

$$T [ {n}_{c} , {k}_{s} ] = {h}_{T} [ {k}_{s} ] * {Y}_{if , 0} [ {n}_{c} , {k}_{s} ]$$

by filtering the signal Y_{if,0}[n_{c},kₛ] with a filter impulse response as follows.

$${h}_{T} [ {k}_{s} ] = \{ \begin{matrix}\frac{{g}_{T}}{{k}_{s , max} - {k}_{s , min}} & for {k}_{s , min} \leq {k}_{s} < {k}_{s , max} \\ 0 & else\end{matrix}$$

The gain of the filter g_{T} allows for adjustment of a false alarm rate. The radar-based altimeter 220 may choose the first peak in the range profile exceeding the threshold to provide the estimated height to the ground, the distance to a treetop (or other object) on the ground, etc.

It will be understood that the radar-based altimeter 220 may be configured to determine the height of the aircraft 100 over the ground via other suitable algorithms and methods in other example embodiments.

The radar-based velocity estimator 230 may be configured to estimate the velocity of the aircraft 100 relative to the ground. The radar-based velocity estimator 230 may utilize one or more of the radar systems 160 to transmit radar signals and estimate the velocity of the aircraft 100 via the reflected radar signals. In example embodiments, the radar-based velocity estimator 230 may utilize the antennas of the side-looking radar systems 164 to transmit radar signals and estimate the velocity of the aircraft 100 relative to the ground via reflected radar signals.

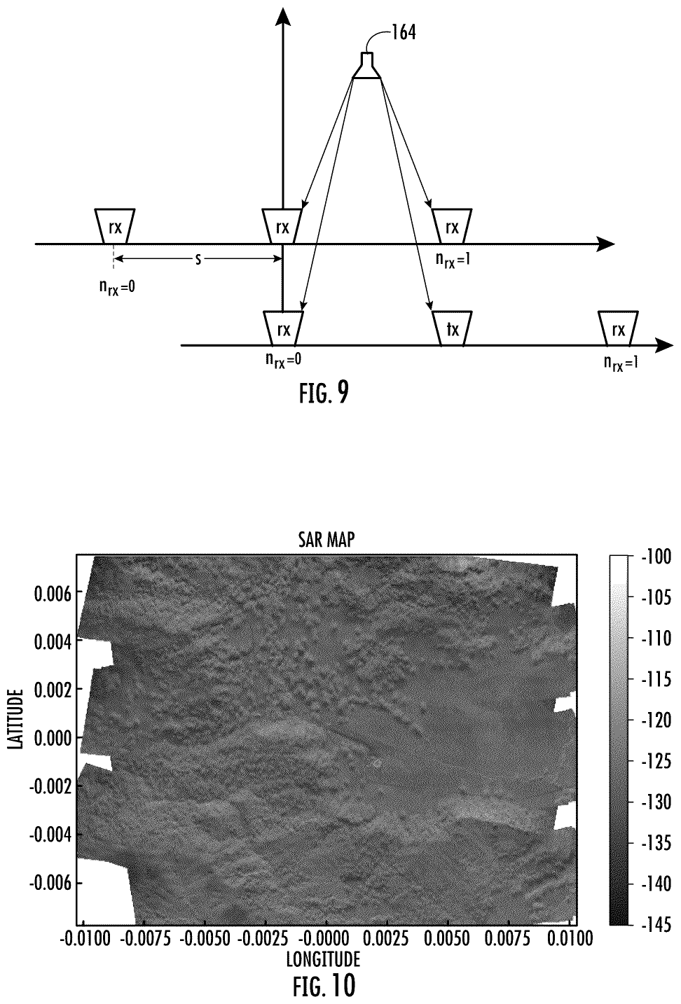

The radar-based velocity estimator 230 may be configured to measure the velocity of the aircraft 100 relative to the ground via suitable algorithms or methods. In example embodiments, the radar-based velocity estimator 230 may be configured to estimate the velocity of the aircraft 100 via correlation methods with displaced antennas, doppler methods, least squares, and/or machine learning techniques. In certain example embodiments, with reference to FIG. 9, when the side-looking radar systems 164 moves in a direction of the aperture, receiving antennas of the side-looking radar systems 164 may observe radar signals reflected by the same scenario, but with a delay in time Δt. Considering the antenna spacing s, the velocity v can be calculated with v=s/Δt.

By neglecting noise and assuming a stationary scenario, the signal models for the range profiles of both receiving antennas if the side-looking radar systems 164 may be connected by the following.

$${S}_{rx 2} ( R , t ) = {S}_{rx 1} ( R , t - Δ t )$$

An estimation of the delay in time Δt can be achieved by a one-dimensional correlation of range profiles in slow time domain as follows.

$$( {S}_{rx 1} ( R , t ) ⋆ {S}_{rx 2} ( R , t ) ) ( τ )$$

An efficient implementation of a correlation may be achieved by transforming the range profiles into the spectral domain using a Fourier transform as follows.

$$( {S}_{rx 1} ( R , t ) ) = {S}_{rx 1} ( R , ω )$$

$$\begin{matrix}( {S}_{rx 2} ( R , t ) ) = {S}_{rx 2} ( R , ω ) \\ = ( {S}_{rx 1} ( R , t - Δ t ) ) \\ = {S}_{rx 1} ( R , ω ) {e}^{- j ωΔ t}\end{matrix}$$

A conjugate complex multiplication may then be performed as follows.

$$\overline{{S}_{rx 1} ( R , ω )} {S}_{rx 2} ( R , ω ) = \overline{{S}_{rx 1} ( R , ω )} {S}_{rx 1} ( R , ω ) {e}^{- j ω Δ t}$$

An inverse Fourier transform may then be performed as follows.

$$\begin{matrix}( {S}_{rx 1} ( R , t ) ★ {S}_{rx 2} ( R , ω ) ) ( τ ) = {- 1}^{} ( \overline{{S}_{rx 1} ( R , ω )} {S}_{rx 2} ( R , ω ) ) \\ = {- 1}^{} ( \overline{{S}_{rx 1} ( R , ω )} {S}_{rx 1} ( R , ω ) {e}^{- j ω Δ t} ) \\ = {R}_{xx} ( R , τ - Δ t )\end{matrix}$$

where Rₓₓ(R,τ) is an autocorrelation function of the range profiles in slow time domain. Regardless of the signal pattern, an autocorrelation function has a maximum value at τ=0. Hence, the estimate [symbol] (T) of the delay in time between the radar signals can be calculated by finding the position of the maximum absolute value of Rₓₓ(R,τ−Δt) for all ranges R as follows.

$$( T ) = {argmax}_{τ} ( \vert {R}_{xx} ( R , τ - Δ t ) \vert )$$

To avoid a few ranges having too much influence on the measurement, the range profiles can be normalized so that all ranges have the same signal energy. Since we assume that the [symbol] (R) is equal for all ranges, we can combine the values by adding up the individual correlations as follows.

$$= {argmax}_{τ} ( {\sum }_{R} \vert {R}_{xx} ( R , τ - Δ t ) \vert )$$

In turn, the velocity v can be calculated with v=s/ [symbol] . In such manner, the radar-based velocity estimator 230 may estimate the velocity of the aircraft 100 relative to the ground.

It will be understood that the radar-based velocity estimator 230 may be configured to estimate the velocity of the aircraft 100 via other suitable algorithms and methods in other example embodiments.

As shown in FIG. 6, the positioning system 200 may include a position estimator 210 that is configured for computing an estimated position of the aircraft 100 based upon various inputs, such as radar-based altitude data from the radar-based altimeter 220, radar-based velocity data from the radar-based velocity estimator 230, GNSS data from the global satellite navigation system 130, IMU data from the inertial measurement system 140, pressure data from the pressure sensor 150, etc. The various inputs for the position estimator 210 may assist with computing of estimated position with desired integrity, which can allow operation of the aircraft 100 even when the GNSS data from the global satellite navigation system 130 is unavailable. Moreover, as discussed in greater detail below, an absolute position of the aircraft 100 may be estimated based on localization of radar images from the radar systems 160.

As shown, the positioning system 200 may include a radar image generator 240 configured for generating a radar image of the landscape below the aircraft 100. For example, the radar image generator 240 may receive data from the side-looking radar systems 164 to generate synthetic-aperture radar (SAR) images of the landscape below the aircraft 100. The radar image generator 240 may be configured to generate the radar images via suitable algorithms or methods. In example embodiments, the radar image generator 240 may obtain SAR radar images via inertial propagation. Moreover, position information for each radar measurement, namely, position relative to position of first radar measurement, may be obtained via inertial propagation. Thus, inertial measurements (specific force, angular rate) from the inertial measurement system 140 may be used to propagate the state estimate (position, velocity, attitude) of the aircraft 100 for the duration of the radar data used to generate the SAR radar image. It will be understood that the radar image generator 240 may generate any suitable type of radar images in alternative example embodiments.

The radar image generator 240 may be configured for obtaining successive radar images. For instance, the radar image generator 240 may be configured such that an interval between the successive radar images is less than twenty seconds (20 s), less than fifteen seconds (15 s), less than ten seconds (10 s), less than five second (5 s), less than two seconds (2), such as no greater than about two seconds (2 s), etc. Moreover, the radar image generator 240 may be configured such that the interval between the successive radar images is greater than a tenth of a second (0.1 s), greater than a half second (0.5 s), such as no less than about one second (1 s), etc. Such intervals may advantageously allow for real-time radar-based location estimation during operation of the aircraft 100.

The radar image generator 240 may be configured for computing the radar images from processed radar data from the radar systems 160. For SAR image reconstruction, the radar image generator 240 may utilize an estimate of the slope of the landscape. For example, the radar image generator 240 may utilize the estimated heights from the radar-based altimeter 220 as the slope estimates of the landscape below the aircraft 100 for SAR image reconstruction. Such estimates are advantageously map independent. In other example embodiments, the radar image generator 240 may utilize map data for the estimated heights, and/or MIMO/interferometric SAR to create two and a half dimensional (2.5D) radar images as the slope estimates of the landscape below the aircraft 100 for SAR image reconstruction. In example embodiments, the radar image generator 240 may also utilize a digital surface model to compute the radar images, e.g., to provide estimated heights.

In example embodiments, the radar image generator 240 may capture radar images with ground-based radar reflectors, bright targets, etc. along a flight path for the aircraft 100. The ground-based radar reflectors, bright targets, etc. may be easily identifiable within the radar image of the landscape below the aircraft 100 from the radar image generator 240. Moreover, the position(s) of the ground-based radar reflectors, bright targets, etc. may be known. Thus, the ground-based radar reflectors, bright targets, etc. may provide easily identifiable objects with known locations in the radar images from the radar image generator 240, which can be accurately and precisely localized on the map by the radar-based localization system 260 as described below.

For SAR image reconstruction, the radar image generator 240 may also utilize an estimate of the velocity of the aircraft 100. For example, the radar image generator 240 may utilize the estimated velocity of the aircraft 100 from the radar-based velocity estimator 230 for SAR image reconstruction.

The radar image generator 240 may be in signal communication with a radar-based localization system 260. Thus, the radar-based localization system 260 may receive data from the radar image generator 240 corresponding to the radar images of the landscape below the aircraft 100. The radar-based localization system 260 may be configured for determining a position of the aircraft 100 based at least in part on a localization of the radar images of the landscape below the aircraft 100 from the radar image generator 240 on a map. For example, as discussed in greater detail below, real-time radar images from the radar image generator 240 may allow for position estimates for the aircraft 100, e.g., via large-scale map correlation and non-uniform Fourier transformation. Continuous updates for the absolute position of the aircraft 100 may allow operation of the aircraft 100 when GNSS data from the global satellite navigation system 130 is unavailable.

The radar-based localization system 260 may also be in signal communication with a map database 250. The map database 250 may include one or more previously determined maps, such as radar reflectively maps. The maps in the map database 250 may be generated with data from a variety of different sources, such as optical images, lidar images, radar images, and/or other suitable sources. When using non-radar maps, correlation between features in the non-radar maps (e.g., optical, lidar, online navigation, and other maps) can require preprocessing and filtering due to images of different measurement systems underlying different scattering behavior and exhibiting different reflection intensities. Thus, in certain example embodiments, the maps in the map database 250 may be radar maps to avoid such preprocessing and filtering.

The radar maps within map database 250 may be acquired from a variety of sources. For example, the maps in map database 250 may be commercially available. The map database 250 may be stored locally on aircraft 100 or remotely and transmitted to the aircraft 100, e.g., as needed.

In example embodiments, the maps in map database 250 may be acquired according to the following. Flights may be performed above the relevant ground, namely a flight path for the aircraft 100, and radar images of the ground may be collected. Features in the radar images may be shifted, e.g., due to false height projection, which can lead to inaccurate position determinations with the map. Thus, the map may be reconstructed to account for feature shifting. For example, features, such as terrain, may be included in the radar map by adding height information from lidar data. For example, the two-dimensional (2D) radar grid from above may be extended by ellipsoidal height, resulting in full geodetic coordinates for every grid point. By converting these grid points to local coordinates with respect to the center of the range compressed frames, a back-projection algorithm can reconstruct directly on a two and a half dimensional (2.5D) surface. Furthermore, lidar point classification can allow the map to consider or neglect vegetation and buildings. As a specific example, orthometric height and intensity data of valid lidar points (depending on selected classification) may be interpolated onto the grid, and the ellipsoidal height may be calculated from the orthometric data. With the additional altitude information, range compressed frames may be back-projected on a 2.5D grid. The resulting radar images may be saved individually with range dependent intensities corrected with respect to the image centers. The images may then be summed and normalized.

An example embodiment of a map from the radar measurements reconstructed on digital elevations is depicted in FIG. 10. As shown, nearly all features, especially creeks, roads, and buildings, appear with sharp and clear edges, indicating accurate radar positions.

It will be understood that the map shown in FIG. 10 and the associated description of the formation of the map is provided by way of example only and is not intended to limit the maps used for localization of the radar image from the radar image generator 240 to such map. In example embodiments, the maps in map database 250 may be other suitable type of maps, including optical, lidar, online navigation, other types of radar maps, etc.

The radar-based localization system 260 may be in signal communication with a map database 250. Thus, the radar-based localization system 260 may receive data from the map database 250 corresponding to a map of the landscape below the aircraft 100. In example embodiments, the radar-based localization system 260 may be configured for requesting a map from the map database 250 based on a last valid position estimate, e.g., when GNSS data from the global satellite navigation system 130 is unavailable. For example, the map database 250 may provide a locally limited section of a map, where the region of interest is based on the last valid position estimate from the position estimator 210. When the radar image from the radar image generator 240 is generated in a short time interval from the last valid position estimate, it is likely that the radar image is within the locally limited section of the map. Moreover, the position estimator 210 may compute position estimates at a high frequency, such as about five hundred Hertz (500 Hz) using IMU data from the inertial measurement system 140. Together with velocity estimates, position drift can be limited, and the locally limited section of the map may be selected. As another example, a particular one of the maps within map database 250 may be selected, e.g., such that the selected map includes the last valid position estimate on the map.

In certain example embodiments, the map from the map database 250 may include an angle of incidence and/or ground track angle for the map. The radar-based localization system 260 may be configured to extract the angle of incidence and/or ground track angle for the map such that the selected map is oriented at the correct perspective for radar-based localization. Thus, e.g., the radar-based localization system 260 may advantageously reconstruct the radar image and provide more accurate position estimates by selecting the map with a matching perspective to the radar image.

In example embodiments, the radar-based localization system 260 may not require ground angle data. As described in greater detail below, the radar-based localization system 260 may be configured to analyze the map to estimate rotation on a first iteration. In other example embodiments, the map database 250 may provide a map with the correct viewing angle based upon the required rotation.

An example embodiment of the radar-based localization system 260 rotating the map from the map database 250 and/or the radar image from the radar image generator 240 in order to align the map and radar image is described below. Initially, the spectrum on a polar grid may be evaluated. Moreover, a translation between radar images may also be present. Thus, magnitudes of the spectra in the polar domain may be used since a translation of an image affects the phase but not the magnitude in spectral domain. However, the unambiguous range for the rotation estimation may be limited to [π/2, π/2]. By applying a one-dimensional cross-correlation of the polar magnitude spectra in the angular domain, the rotation φ of the radar image in relation to the map may be estimated. The most likely value of the rotation \hat{φ} can correspond to the value that maximizes the utility function of the one-dimensional cross-correlation.

The radar-based localization system 260 may be configured for correcting the radar image from the radar image generator 240 by the rotation \hat{φ}. Thus, e.g., the radar-based localization system 260 may be configured for rotating the radar image by the estimated rotation \hat{φ}, e.g., around the image center. The radar-based localization system 260 may also be configured for performing a two-dimensional interpolation to align the radar image with the map. Moreover, the radar-based localization system 260 may also be configured estimating the position of the rotated radar image on the map by applying a two-dimensional cross-correlation. Thus, e.g., the radar-based localization system 260 may calculate the estimated position \hat{z}_{cntr} of the image center that corresponds to values that maximize the utility function of the two-dimensional cross-correlation.

Since the local distance z_{SAR} between the radar system 160 and the center of the radar image is known, the radar-based localization system 260 may compute the position estimate \hat{z} of the aircraft 100 in global coordinates with the following

$$\hat{z} = {\hat{z}}_{cntr} - {\hat{R}}_{φ} {z}_{SAR}$$

where \hat{R}_{φ} is the two-dimensional rotation matrix for p. In such manner, the radar-based localization system 260 may estimate the absolute position of the aircraft 100.

It will be understood that the radar-based localization system 260 may be configured to estimate the position of the aircraft 100 via other suitable algorithms and methods in other example embodiments. For example, the radar-based localization system 260 may be configured to estimate the position of the aircraft 100 by least squares, feature-based, geometric method (terrain contours), interferometric radar images to include terrain height information, machine learning, and other techniques.

As noted above, the position estimator 210 may be configured for computing the estimated position of the aircraft 100 based upon various inputs, such as radar-based altitude data from the radar-based altimeter 220, radar-based velocity data from the radar-based velocity estimator 230, GNSS data from the global satellite navigation system 130, IMU data from the inertial measurement system 140, pressure data from the pressure sensor 150, as well as the estimated position of the aircraft 100 from the radar-based localization system 260.

In general, the position estimator 210 may be configured to provide accurate velocity estimates for the aircraft 100 in order to allow for computing high quality radar images with the radar image generator 240 and/or to provide a full navigation solution with position, velocity, and attitude estimates, e.g., without access to GNSS data. With reference to FIG. 6, the position estimator 210 may be configured for operating in three modes: (1) position, velocity, and/or attitude estimates via inertial measurements from the IMU system 140 and without radar measurements; (2) position, velocity, and/or attitude estimates via inertial measurements from the IMU system 140 with corrections via velocity estimates from the radar-based velocity estimator 230; and (3) position, velocity, and/or attitude estimates via inertial measurements from the IMU system 140 with corrections via velocity estimates from the radar-based velocity estimator 230 as well as location estimates for the aircraft 100 based at least in part on localization of the radar images of the landscape below the aircraft 100 from the radar-based localization system 260 on a map as described above. The position estimator 210 may be configured to implement any of the three modes described above to assist with navigation of the aircraft 100. Additionally, all three modes may process pressure measurements from system 150 and/or radar-based altimeter measurements from system 220.

In example embodiments, the position estimator 210 may include an Error-State Kalman filter in closed-loop implementation that provides corrections to inertial estimates from the IMU system 140. In example embodiments, the state of the Kalman filter in error-state formulation may be zero (0) except directly after processing a measurement that is not an IMU measurement. The position, velocity, attitude states may be maintained outside of the Kalman filter, and only the errors of position, velocity, attitude state estimates may be estimated by the Kalman filter. The Kalman filter may always contain the covariance of the position, velocity, attitude states.

The position estimator 210 may process the following measurements in all or in a subset of the three modes: (1) specific force and angular rate measurements from the IMU system 140; (2) barometric pressure from the pressure sensor 150; (3) radar-based time difference measurements from the radar-based velocity estimator 230, e.g., as described above the radar-based velocity estimator 230 may utilize one or more of the radar systems 160 to transmit radar signals and estimate the velocity of the aircraft 100 via the reflected radar signal; and (4) horizontal position estimate and/or ground track angle estimate for the aircraft 100 from map-based localization using radar images by the radar-based localization system 260. In example embodiments, direct velocity estimates may be obtained via Doppler methods. The position estimator 210 may also use a GNSS-aided navigation filter to initialize the GNSS-denied navigation filter. This GNSS-aided filter may process GNSS position measurements from the global satellite navigation system 130.

The position estimator 210 may be configured with the Kalman filter that includes a state vector, prediction and measurement update steps, and initialization as described below. The state vector may be stored outside of the Kalman filter and predicted using the inertial navigation equations. The state vector may include position, velocity, attitude, gyroscope bias, accelerometer bias, angular velocity, and linear acceleration. More specifically, the states of the state vector may be given as the following:

$${p}_{GB}^{G}$$

corresponding to a global position of a body frame in geodetic frame (latitude, longitude, ellipsoidal height);

$${v}_{EB}^{N}$$

corresponding to a velocity of the body frame with respect to an Earth frame, expressed in navigation frame;

$${R}_{N}^{B}$$

corresponding to an attitude from the navigation frame to the body frame, stored as a direction cosine matrix;
b_{gyro} corresponding to a gyroscope bias;
b_{acc} corresponding to an accelerometer bias;

$${ω}_{IB}^{B}$$

corresponding to an angular velocity of the body frame with respect to an inertial frame, expressed in the body frame (calculated

$${a}_{IB}^{B}$$

linear acceleration of the body frame with respect to the inertial frame, expressed in the body frame); and

$${a}_{IB}^{B}$$

corresponding to a linear acceleration of the body frame with respect to the inertial frame, expressed in the body frame.

The Kalman filter of the position estimator 210 may be an Error-State Kalman filter with the following states:

$$x = \begin{matrix}\begin{matrix}{Ψ}_{N -}^{N} \\ δ {v}_{EB}^{N}\end{matrix} \\ δ {p}_{B}\end{matrix}$$

where

$${Ψ}_{N -}^{N}$$

corresponds to Euler angles describing the rotation from the estimated navigation frame before measurement update to the true navigation frame;

$${v}_{EB}^{N}$$

corresponds to a velocity of the body frame with respect to the Earth frame expressed in navigation frame coordinates; and

$${p}_{GB}^{G}$$

corresponds to a position of the body frame in geodetic coordinates (latitude, longitude, altitude).

The Kalman filter of the position estimator 210 may use specific force and angular rate measurements from the IMU system 140 to predict the state vector. It will be understood that other states may be included for the Kalman filter in other example embodiments, such as gyroscope and accelerometer bias, barometric pressure bias, etc. In addition to the state vector, the covariance may be propagated using the Kalman filter equations.

In example embodiments, the position estimator 210 may be configured for a closed-loop error-state implementation. The a-posteriori state estimate may be given as follows.

$${\hat{x}}^{+} = {\hat{x}}^{-} - δ \hat{x}$$

Where:
   \hat{x}⁻ corresponds to an a-priori state estimate (before processing the measurement);
   \hat{x}⁺ corresponds to an a-posteriori state estimate (after processing the measurement); and
δ\hat{x} corresponds to an error state, estimated by the Kalman filter.

For attitude, the Kalman filter of the position estimator 210 may be configured to “subtract” the estimated attitude error from the inertial propagation state by a multiplication with a rotation matrix. A small angle approximation may be valid when the Kalman filter is initialized with an accurate attitude estimate. The Kalman filter implementation may be a closed-loop implementation such that after each measurement the inertial navigation state vector is corrected for the estimated error state and the error state vector is reset to zero. Equations for the feedback step after each measurement are as follows:

$${\hat{R}}_{N}^{{B}^{+}} = {\hat{R}}_{N}^{{B}^{-}} {\hat{R}}_{{N}^{-}}^{{N}^{T}}$$

$${\hat{v}}_{EB}^{{N}^{+}} = {\hat{v}}_{EB}^{{N}^{-}} - δ {\hat{v}}_{EB}^{N}$$

$${\hat{p}}_{B}^{+} = {\hat{p}}_{B}^{-} - δ {\hat{p}}_{B}$$

The measurement equation of the Kalman filter processes the measurement innovation as follows.

$$δ z = \tilde{z} - \hat{z}$$

where \tilde{z} corresponds to the measurement, δz corresponds to the measurement innovation, and \tilde{z} corresponds to the expected measurement based on a-priori state estimate.

The position estimator 210 may be initialized with the state vector and covariance matrix from a GNSS-aided navigation filter when the GNSS data becomes unavailable. In other example embodiments, the position estimator 210 may be initialized based on the results from the GNSS-aided filter.

The first filter option may not process any measurements other than specific force and angular rate measurements from the IMU system 140. Therefore, the resulting solution is pure inertial propagation. Position, velocity, and attitude errors will grow over time since pure inertial propagation offers only short-term stability.

The second filter option may process radar time difference measurements from the radar-based velocity estimator 230 in addition to inertial measurements from the IMU system 140. Since the main effect of processing radar time difference measurements is to aid velocity estimation in the direction of travel, the velocity estimation in the direction of travel can be long-term stable.

The third filter option may use the resulting state estimate from the second filter option to compute the radar image with the radar image generator 240. The third filter option also has a feedback from the radar-based localization system 260. In addition to inertial measurements from the IMU system 140 and radar time difference measurements from the radar-based velocity estimator 230, horizontal position estimates from the radar-based localization system 260 via localizing the radar image on a map are processed as measurements. The horizontal position measurements may include latitude and longitude estimates for the aircraft 100.

In certain example embodiments, the filter(s) of the positioning system 210 may provide advantageously provide desired integrity and continuity, fault detection and exclusion, consistency checks, etc. Moreover, with parallel filters, the positioning system 210 may switch between available positioning solutions, such as GNSS data, radar-based odometry data (e.g., frame-to-frame state changes between consecutive radar images), map-based localization data, etc. As an example, the parallel filters may check for consistency, e.g., via a separate GNSS filter and a separate radar-based filter.

As may be seen from the above, the positioning system 210 may processes the radar-based measurements (radar measurements for velocity estimation, position estimate from map-based localization and/or localization results) to estimate position, velocity, attitude of the aircraft 100. Additionally, inertial sensor biases, airspeed, etc. may be estimated by the positioning system 210. The positioning filter may be a Kalman filter (including variants, such as Extended Kalman filter, Unscented Kalman filter, etc.), a graph optimization algorithm, Monte Carlo methods (particle filter), etc. The positioning system 210 may use data from the IMU system 140 (such as specific force, angular rate, etc.) for state prediction.

In certain example embodiments, the positioning system 210 may also process other measurements to assist with high integrity estimates of the position of aircraft 100. For example, the positioning system 210 may also utilize GNSS data from the global satellite navigation system 130, pseudolite system measurements, modulated reflector-based measurements, etc. With respect to pseudolite system measurements, pseudolites may be installed along a flight path for the aircraft 100. Pseudolite data may be used in combination with or as an alternative to GNSS data from the global satellite navigation system 130 to assist with estimating the position of aircraft 100.

With respect to ground-based radar reflectors, reflectors may be installed along a flight path for the aircraft 100. The ground-based radar reflectors may be simple reflectors (no modulation) or modulated reflectors. The modulated radar reflectors may include one or more modulation components (e.g., a mixer, switches, amplifiers, and/or other non-linear elements) that can modulate radar returns. The radar returns can be modulated according to one or more modulation schemes that include but are not limited to modulation techniques such as changing the amplitude, frequency and/or phase of the radio signals. The modulation schemes can include one common modulation scheme, multiple reflector specific modulation schemes, or route specific modulation schemes. The ground-based radar reflectors may be easily identifiable within the radar image of the landscape below the aircraft 100 from the radar image generator 240. Moreover, the position(s) of the ground-based radar reflectors may be known. Thus, the ground-based radar reflectors may assist with estimating the position of the aircraft 100 by providing easily identifiable objects with known locations in the radar images from the radar image generator 240, which can be easily localized on the map by the radar-based localization system 260. Such ground-based radar reflectors may also be used as integrity checks and/or to bound position estimates based on the radar images.

As may be seen from the above, the positioning system 200 may acquire radar images of the ground below the aircraft 100 using radar-based and/or inertial estimates of velocity and relative position, e.g., rather than GNSS-based estimates. Thus, the radar-based portions of the positioning system 200 may allow for estimating the velocity and position of the aircraft 100 without reliance upon GNSS data.

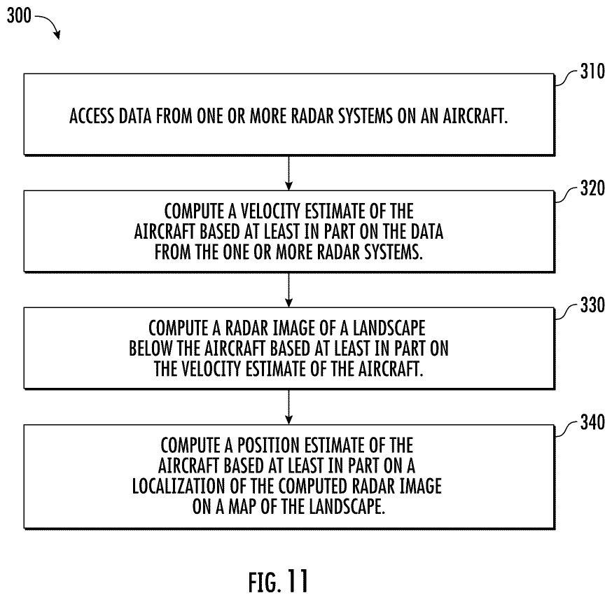

FIG. 11 illustrates a method 300 for radar-based localization for an aircraft according to example implementations of the present disclosure. One or more portions of the method 300 may be implemented by one or more computing devices such as for example, the computing devices/systems described in reference to the other figures. Moreover, one or more portions of the method 300 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 300.

FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

Method 300 is described in greater detail below in the context of the aircraft 100. However, it will be understood that method 300 may be used in or with other aircraft and avionics systems to provide location estimates for an aircraft during flight.

At 310, a computing system (e.g., positioning system 200) may access data from one or more radar systems on an aircraft. For example, positioning system 200 may access data from radar systems 160 at 310. It will be understood that data from one or more of radar systems 160 may be accessed at 310 by various components of positioning system 200. For example, at 310, the radar-based altimeter 220 may receive data from the downwardly-facing radar system 166 at 310, the radar-based velocity estimator 230 may receive data from the side-looking radar systems 164 and/or the forward-looking detect-and-avoid (DAA) radar system 162, and the radar image generator 240 may receive data from the side-looking radar systems 164 and/or the forward-looking detect-and-avoid (DAA) radar system 162. It will be understood that data from other radar systems 160 may also be accessed at 310. Moreover, the data from the radar systems 160 may be accessed simultaneously, sequentially, separately, or in any other manner depending upon the subsequent use for the data from the radar systems 160 in method 300.

At 320, the computing system (e.g., positioning system 200) may compute a velocity estimate of the aircraft based at least in part on the data from 310. For example, at 320, positioning system 200 may compute the velocity estimate based at least in part on the data from the side-looking radar systems 164 and/or the forward-looking detect-and-avoid (DAA) radar system 162 from 310. Moreover, the radar-based velocity estimator 230 may compute the velocity estimate for aircraft 100 based on the data from the side-looking radar systems 164 and/or the forward-looking detect-and-avoid (DAA) radar system 162 from 310. Thus, e.g., the computing system may estimate the velocity of the aircraft based on displaced antenna processing or other suitable methods of processing the data from the radar systems at 320.

At 330, the computing system (e.g., positioning system 200) may compute a radar image of a landscape below the aircraft based at least in part on the velocity estimate of the aircraft from 320, e.g., as well as data from 310. For example, at 330, positioning system 200 may compute the radar image based at least in part on data from the side-looking radar systems 164 and/or the forward-looking detect-and-avoid (DAA) radar system 162 from 310 as well as the velocity estimate from 320. Moreover, the radar image generator 240 may compute the radar image of the landscape below the aircraft 100 based on the data from the side-looking radar systems 164 and/or the forward-looking detect-and-avoid (DAA) radar system 162 from 310. Thus, e.g., the computing system may compute a radar image of the landscape below the aircraft 100 based on SAR processing or other suitable methods of processing the data from the radar systems at 330. By using the radar-based velocity estimate from 330, the computation of the radar image for the aircraft may advantageously be made without reference to data a global navigation satellite system (GNSS), e.g., when the GNSS system is unavailable.

In certain example embodiments, method 300 may also include computing an altitude estimate of the aircraft based at least in part on the data from 310. For example, the positioning system 200 may compute the altitude estimate based at least in part on the data from the downwardly-facing radar system 166. Moreover, the radar-based altimeter 220 may receive data from the downwardly-facing radar system 166 and compute the altitude estimate of the aircraft 100 based on the radar data. The altitude estimate may be used to assist with computing the radar image at 330. For instance, the radar-based altitude estimate may be used as slope estimates of the landscape below the aircraft for SAR image reconstruction.

At 340, the computing system (e.g., positioning system 200) may compute a position estimate of the aircraft based at least in part on a localization of the computed radar image from 330 on a map of the landscape. For example, at 340, the radar-based localization system 260 may compute the position estimate based at least in part on localization of the computed radar image from 330 on a map of the landscape from the map database 250. Moreover, real-time radar images calculated by the radar image generator 240 at 330 may be localized on a map from the map database 250 at 340, e.g., via large-scale map correlation and non-uniform Fourier transformation. In example embodiments, the localization of the computed radar image from 330 on the map may include rotating the based at least in part on an angle of incidence for the radar image, e.g., using a one-dimensional cross-correlation. In example embodiments, the method may include selecting the map from the map database 250 based at least in part on the angle of incidence for the radar image. By using the radar image from 330, the computation of the position estimate for the aircraft may advantageously be made without reference to data a global navigation satellite system (GNSS), e.g., when the GNSS system is unavailable.

In example embodiments, method 300 may include identifying a reference radar reflective target within the radar image. For example, the radar-based localization system 260 may compute the position estimate based at least in part on the ground-based radar reflectors, bright targets, etc. with the radar image from 340. The ground-based radar reflectors, bright targets, etc. may be easily identifiable within the radar image of the landscape below the aircraft 100. Moreover, the position(s) of the ground-based radar reflectors, bright targets, etc. may be known. Thus, the ground-based radar reflectors, bright targets, etc. may provide easily identifiable objects with known locations in the radar images, which can be easily localized on the map by the radar-based localization system 260.

In certain example embodiments, method 300 may also include accessing data from one or more inertial measurement sensors on the aircraft. For example, the computing system (e.g., positioning system 200) may also access data from the one or more inertial measurement sensors. Moreover, the positioning system 200 may receive IMU data from the inertial measurement system 140. The IMU data may be used to assist with computing the velocity estimate at 320, computing the radar image at 330, and/or computing the position estimate at 340. For instance, the positioning system 200 may use the IMU data to compute values with increased integrity relative to computations without the IMU data.

FIG. 12 depicts example system components of a computing system 1005 according to example implementations of the present disclosure. The computing system 1005 may include one or more computing devices 1010. The computing devices 1010 of the computing system 1005 may include one or more processors 1015 and a memory 1020. The processors 1015 can be any suitable processing device (e.g., a processor core, a GPU, a microprocessor, an ASIC, a FPGA, a controller, a microcontroller, etc.) and may be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 may store information that can be accessed by the processors 1015. For instance, the memory 1020 (e.g., one or more non-transitory computer-readable storage mediums, memory devices) may include computer-readable instructions 1025 that can be executed by the processors 1015. The instructions 1025 may be software written in any suitable programming language or may be implemented in hardware. Additionally, or alternatively, the instructions 1025 may be executed in logically or virtually separate threads on processors 1015.

For example, the memory 1020 may store instructions 1025 that when executed by the processors 1015 cause the processors 1015 to perform operations such as any of the operations and functions of any of the computing systems (e.g., aircraft system) or computing devices (e.g., the flight computer), as described herein.

The memory 1020 may store data 1030 that can be obtained, received, accessed, written, manipulated, created, or stored. The data 1030 may include, for instance, input data, trim values, output data, or other data/information described herein. In some implementations, the computing devices 1010 may access from or store data in one or more memory devices that are remote from the computing system 1005.

The computing devices 1010 can also include a communication interface 1035 used to communicate with one or more other systems. The communication interface 1035 may include any circuits, components, software, etc. for communicating via one or more networks. In some implementations, the communication interface 1035 may include for example, one or more of a communications controller, receiver, transceiver, transmitter, port, conductors, software or hardware for communicating data/information.

FIG. 12 illustrates one example computing system 1005 that may be used to implement the present disclosure. Other computing systems can be used as well. Computing tasks discussed herein as being performed at computing devices onboard the aircraft may instead be performed remote from the aircraft (e.g., a network connected computing system), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

As may be seen from the above, the present subject matter may advantageously provide accurate estimates of velocity and position for an aircraft during a time interval when radar data is acquired such that a high-quality radar image can be constructed. GNSS-based systems may estimate velocity and position but can be unavailable. The present subject matter may provide radar-based velocity and position estimates to compute high-quality radar images, which do not depend on GNSS data. Thus, the positioning system can entirely separate radar-based state estimation from GNSS-based state estimation.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.” As used herein, the terms “first,” “second,” and “third” may be used interchangeably to distinguish one component from another and are not intended to signify location or importance of the individual components. The terms “includes” and “including” are intended to be inclusive in a manner similar to the term “comprising.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

The terms “coupled,” “fixed,” “attached to,” and the like refer to both direct coupling, fixing, or attaching, as well as indirect coupling, fixing, or attaching through one or more intermediate components or features, unless otherwise specified herein.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply embodiments of the disclosure. Hence, specific dimensions and other physical characteristics related to the embodiments disclosed herein are not to be considered as limiting.

### Example Embodiments

First example embodiment: A method for radar-based localization, comprising: accessing, with a computing device on an aircraft, data from one or more radar systems on the aircraft; computing, with the computing device, a velocity estimate of the aircraft based at least in part on the data from the one or more radar systems on the aircraft; computing, with the computing device, a radar image of a landscape below the aircraft based at least in part on the velocity estimate of the aircraft; and computing, with the computing device, a position estimate of the aircraft based at least in part on a localization of the computed radar image on a map of the landscape.

Second example embodiment: The method of the first example embodiment, further comprising accessing, with the computing device, data from one or more inertial measurement sensors on the aircraft, wherein computing the velocity estimate of the aircraft comprises computing the velocity estimate of the aircraft based at least in part on the data from the one or more radar systems on the aircraft and the data from the one or more inertial measurement sensors on the aircraft.

Third example embodiment: The method of either the first example embodiment or the second example embodiment, further comprising computing, with the computing device, an altitude estimate of the aircraft based at least in part on the data from the one or more radar systems on the aircraft.

Fourth example embodiment: The method of any one of the first through third example embodiments, wherein computing the radar image comprises computing the radar image based at least in part on the velocity estimate of the aircraft, the altitude estimate of the aircraft, and the data from the one or more radar systems on the aircraft.

Fifth example embodiment: The method of any one of the first through fourth example embodiments, further comprising computing, with the computing device, one or both of an angle of incidence and a ground track angle for the radar image of the landscape below the aircraft.

Sixth example embodiment: The method of any one of the first through fifth example embodiments, wherein computing the position estimate of the aircraft comprises computing a rotation of the radar image relative to the map of the landscape based at least in part on the ground track angle for the radar image.

Seventh example embodiment: The method of any one of the first through sixth example embodiments, further comprising selecting, with the computing device, the map of the landscape from a plurality of maps of the landscape based at least in part on one or both of the angle of incidence and the ground track angle for the radar image.

Eighth example embodiment: The method of any one of the first through seventh example embodiments, wherein computing the position estimate of the aircraft comprises identifying a reference radar reflective target within the computed radar image.

Nineth example embodiment: The method of any one of the first through eighth example embodiments, wherein the radar image comprises a synthetic-aperture radar image of the landscape below the aircraft.

Tenth example embodiment: The method of any one of the first through nineth example embodiments, wherein an interval between successive radar images is no less than one-tenth second and no greater than five seconds.

Eleventh example embodiment: The method of any one of the first through tenth example embodiments, wherein the position estimate of the aircraft is computed without position estimate data from a global navigation satellite system.

Twelfth example embodiment: The method of the eleventh example embodiment, wherein the one or more radar systems comprises a plurality of side-looking radar systems.

Thirteenth example embodiment: A system for radar-based localization, the system comprising: one or more processors; and one or more non-transitory computer-readable media that store instructions that are executable by the one or more processors to perform operations, the operations comprising accessing data from one or more radar systems on the aircraft, computing a velocity estimate of the aircraft based at least in part on the data from the one or more radar systems on the aircraft, computing a radar image of a landscape below the aircraft based at least in part on the velocity estimate of the aircraft, and computing a position estimate of the aircraft based at least in part on a localization of the computed radar image on a map of the landscape.

Fourteenth example embodiment: The system of the thirteenth example embodiment, wherein the operations further comprise accessing data from one or more inertial measurement sensors on the aircraft, wherein computing the velocity estimate of the aircraft comprises computing the velocity estimate of the aircraft based at least in part on the data from the one or more radar systems on the aircraft and the data from the one or more inertial measurement sensors on the aircraft.

Fifteenth example embodiment: The system of either the thirteenth example embodiment or fourteenth example embodiment, wherein the operations further comprise computing an altitude estimate of the aircraft based at least in part on the data from the one or more radar systems on the aircraft.

Sixteenth example embodiment: The system of any one of the thirteenth through fifteenth example embodiments, wherein computing the radar image comprises computing the radar image based at least in part on the velocity estimate of the aircraft and the altitude estimate of the aircraft.

Seventeenth example embodiment: The system of any one of the thirteenth through sixteenth example embodiments, wherein the operations further comprise computing one or both of an angle of incidence and a ground track angle for the radar image of the landscape below the aircraft.

Eighteenth example embodiment: The system of any one of the thirteenth through seventeenth example embodiments, wherein computing the position estimate of the aircraft comprises computing a rotation of the radar image relative to the map of the landscape based at least in part on the ground track angle for the radar image.

Nineteenth example embodiment: The system of any one of the thirteenth through eighteenth example embodiments, wherein the operations further comprise selecting the map of the landscape from a plurality of maps of the landscape based at least in part on one or both of the angle of incidence and the ground track angle for the radar image.

Twentieth example embodiment: The system of any one of the thirteenth through nineteenth example embodiments, wherein computing the position estimate of the aircraft comprises identifying a reference radar reflective target within the computed radar image.

Twenty-first example embodiment: The system of any one of the thirteenth through twentieth example embodiments, wherein the radar image comprises a synthetic-aperture radar image of the landscape below the aircraft.

Twenty-second example embodiment: The system of any one of the thirteenth through twenty-first example embodiments, wherein an interval between successive radar images is no less than one-tenth second and no greater than five seconds.

Twenty-third example embodiment: The system of any one of the thirteenth through twenty-second example embodiments, wherein the position estimate of the aircraft is computed without position estimate data from a global navigation satellite system.

Twenty-fourth example embodiment: The system of any one of the thirteenth through twenty-third example embodiments, wherein the one or more radar systems comprises a plurality of side-looking radar systems.

What is claimed is:

1. A method for radar-based localization, comprising:
accessing, with a computing device on an aircraft, data from one or more radar systems on the aircraft;
computing, with the computing device, a velocity estimate of the aircraft based at least in part on the data from the one or more radar systems on the aircraft;
computing, with the computing device, a radar image of a landscape below the aircraft based at least in part on the velocity estimate of the aircraft; and
computing, with the computing device, a position estimate of the aircraft based at least in part on a localization of the computed radar image on a map of the landscape.

2. The method of claim 1, further comprising accessing, with the computing device, data from one or more inertial measurement sensors on the aircraft, wherein computing the velocity estimate of the aircraft comprises computing the velocity estimate of the aircraft based at least in part on the data from the one or more radar systems on the aircraft and the data from the one or more inertial measurement sensors on the aircraft.

3. The method of claim 1, further comprising computing, with the computing device, an altitude estimate of the aircraft based at least in part on the data from the one or more radar systems on the aircraft.

4. The method of claim 3, wherein computing the radar image comprises computing the radar image based at least in part on the velocity estimate of the aircraft, the altitude estimate of the aircraft, and the data from the one or more radar systems on the aircraft.

5. The method of claim 1, further comprising computing, with the computing device, one or both of an angle of incidence and a ground track angle for the radar image of the landscape below the aircraft.

6. The method of claim 5, wherein computing the position estimate of the aircraft comprises computing a rotation of the radar image relative to the map of the landscape based at least in part on the ground track angle for the radar image.

7. The method of claim 5, further comprising selecting, with the computing device, the map of the landscape from a plurality of maps of the landscape based at least in part on one or both of the angle of incidence and the ground track angle for the radar image.

8. The method of claim 1, wherein computing the position estimate of the aircraft comprises identifying a reference radar reflective target within the computed radar image.

9. The method of claim 1, wherein the radar image comprises a synthetic-aperture radar image of the landscape below the aircraft.

10. The method of claim 1, wherein an interval between successive radar images is no less than one-tenth second and no greater than five seconds.

11. The method of claim 1, wherein the position estimate of the aircraft is computed without position estimate data from a global navigation satellite system.

12. The method of claim 1, wherein the one or more radar systems comprises a plurality of side-looking radar systems.

13. A system for radar-based localization, the system comprising:
one or more processors; and
one or more non-transitory computer-readable media that store instructions that are executable by the one or more processors to perform operations, the operations comprising
accessing data from one or more radar systems on the aircraft,
computing a velocity estimate of the aircraft based at least in part on the data from the one or more radar systems on the aircraft,
computing a radar image of a landscape below the aircraft based at least in part on the velocity estimate of the aircraft, and
computing a position estimate of the aircraft based at least in part on a localization of the computed radar image on a map of the landscape.

14. The system of claim 13, wherein the operations further comprise accessing data from one or more inertial measurement sensors on the aircraft, wherein computing the velocity estimate of the aircraft comprises computing the velocity estimate of the aircraft based at least in part on the data from the one or more radar systems on the aircraft and the data from the one or more inertial measurement sensors on the aircraft.

15. The system of claim 13, wherein the operations further comprise computing an altitude estimate of the aircraft based at least in part on the data from the one or more radar systems on the aircraft.

16. The system of claim 15, wherein computing the radar image comprises computing the radar image based at least in part on the velocity estimate of the aircraft and the altitude estimate of the aircraft.

17. The system of claim 13, wherein the operations further comprise computing one or both of an angle of incidence and a ground track angle for the radar image of the landscape below the aircraft.

18. The system of claim 17, wherein computing the position estimate of the aircraft comprises computing a rotation of the radar image relative to the map of the landscape based at least in part on the ground track angle for the radar image.

19. The system of claim 17, wherein the operations further comprise selecting the map of the landscape from a plurality of maps of the landscape based at least in part on one or both of the angle of incidence and the ground track angle for the radar image.

20. The method of claim 13, wherein an interval between successive radar images is no less than one-tenth second and no greater than five seconds.
